(19) United States
(12) Patent Application Publication
(10) Pub. No.: US 2016/0320552 A1
(43) Pub. Date: Nov. 3, 2016

(54) BACKLIGHT UNIT AND A DISPLAY

(71) Applicant: Wuhan China Star Optoelectronics Technology Co., Ltd., Wuhan, Hubei (CN)

(72) Inventor: Gege ZHOU, Shenzhen, Guangdong (CN)

(21) Appl. No.: 14/758,232

(22) PCT Filed: May 22, 2015
(86) PCT No.: PCT/CN2015/079586

§ 371 Date: Jun. 27, 2015

(30) Foreign Application Priority Data
Apr. 29, 2015 (CN) 201510216541.2

(51) Int. Cl. F21V 8/00

(52) U.S. Cl. CPC G02B 6/0091; G02B 6/0068

(57) ABSTRACT

The present invention provides a backlight unit (BLU) including a plastic frame, a light guide plate, an optical film group, and at least one light source; the light source and the light guide plate set and fixed in the plastic frame; the light guide plate including a light incident surface and a light emitting surface next to the light incident surface; the light source set relative to the light incident surface of the light guide plate; the optical film group including a first film having a first lateral side; the first lateral side having at least two notches; the first film set on the light emitting surface; the first lateral side and the light incident surface being on the same plane; and the light source located between the two notches. The present invention also provides a display.

### CROSS REFERENCE TO RELATED APPLICATIONS

The present invention claims the right of priority based on China Patent Application No. 201510216541.2 entitled “A BACKLIGHT UNIT AND A DISPLAY”, filed on Apr. 29, 2015, which is incorporated herein by reference.

### BACKGROUND

1. Technical Field

The present invention relates to liquid crystal display field, and more particularly, to a backlight unit (BLU) and a display.

2. Description of Related Art

A liquid crystal display (LCD) as a displaying element of electronic apparatus has been applied in all kinds of electronic products. With the development of thinning the electronic product, the bezel of the electronic product is designed to be thinner. A backlight unit (BLU) is an important element in LCD so the requirement of light efficiency of a light bar and the optics becomes higher.

The conventional BLU includes light guide plate, a BLU set on the light guide plate, plastic bezels around the BLU, a flexible circuit board, and a shielding tape. The flexible circuit board is fixed on the BLU and the plastic bezel by the shielding tape. The BLU is fixed on the plastic bezel by the shielding tape as well. The LCD is fixed on the periphery of the BLU by the twin adhesive.

However, because of the design of the narrow bezel, the bezel becomes narrow. The light source is closer to a viewing region so a viewing region at the light incident side has bright region easily and the optical effect of the BLU is influenced.

### SUMMARY

For solving the problem of the conventional technique, the present invention provides a backlight unit (BLU) to avoid that a viewing region at the light incident side has bright region and ensure the optical effect of the BLU.

The present invention further provides a display.

For achieving the aforementioned purpose, the present invention adopts the technique below.

A backlight unit (BLU) including a plastic frame, a light guide plate, an optical film group, and at least one light source; the light source and the light guide plate set and fixed in the plastic frame; the light guide plate including a light incident surface and a light emitting surface next to the light incident surface; the light source set relative to the light incident surface of the light guide plate; the optical film group including a first film having a first lateral side; the first lateral side having at least two notches; the first film set on the light emitting surface; the first lateral side and the light incident surface being on the same plane; and the light source located between the two notches.

The first film includes a plate body and an extensive plate, the extensive plate is parallel to one side of the plate body and extended from and away the plate body, and the first lateral side is one side of the extensive plate.

The optical film group includes a plurality of second films which are stacked, the same side of each of the plurality of second films is a second side, and the second side and the first side face the same direction and they form stair configuration.

A shape of the notch is selected from a group consisting of arc, semicircle, oval, triangle, and polygon.

Quantity of the notches is N, there are predetermined pitches among N notches, quantity of light source is N−1, and the light source is located between the adjacent two notches.

A region of the extensive plate between the second side and the first side is a first stair, a second stair is set inside of the plastic frame and relative to the first stair, the light source comprises a circuit board and a light-emitting element set on the circuit board, and the circuit board is fixed on the first stair and the second stair.

The first stair is between two notches.

The BLU further includes a back plate including a bottom plate and a side plate, and the plastic frame and the optical film group are fixed on the side plate of the back plate by the double-sided tape.

A reflective sheet is set between the back plate and the BLU.

The present invention further provides a display including the BLU and a liquid crystal (LC) panel, and the LC panel set on the BLU and fixed on the BLU by double-sided tape.

The BLU of the present invention includes a plurality of light sources set on one side of light incident surface of the light guide plate next to each other in the plastic frame. The first film of the optical film group and the light incident surface are set flush. Each light source is located between the two adjacent notches and the first film between the two adjacent notches shelters the light source. Therefore, the forward brightness of the location of the light source can be lowered and the problem that the bright region of the BLU is closer to the light source can be solved.

### BRIEF DESCRIPTION OF THE DRAWINGS

The accompanying drawings are included to provide easy understanding of the application, are incorporated herein and constitute a part of this specification. The drawings illustrate embodiments of the application and, together with the description, serve to illustrate the principles of the application.

FIG. 1 is a cross-sectional view of a BLU structure along a light source in accordance with an embodiment of the present invention.

FIG. 2 is a schematic view of an optical film of the BLU of FIG. 1.

FIG. 3 is a cross-sectional view of a circuit board along the light source of the BLU of FIG. 1.

### DESCRIPTION OF THE PREFERRED EMBODIMENTS

To better and concisely explain the disclosure, the same name or the same reference number given or appeared in different paragraphs or figures along the specification should has the same or equivalent meanings while it is once defined anywhere of the disclosure.

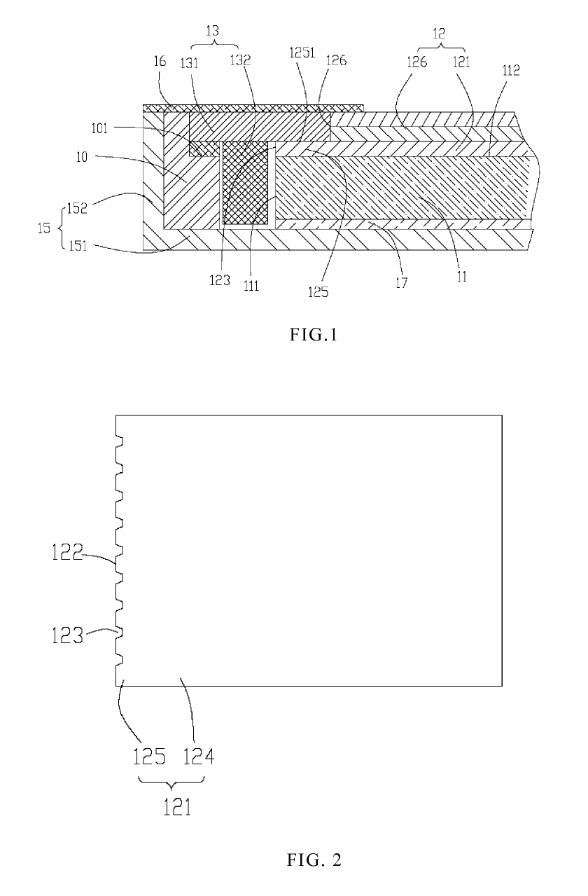

Referring FIG. 1, an embodiment of the present invention provides a backlight unit (BLU) and a display. The display includes the BLU and a liquid crystal (LC) panel. The LC panel is set on the BLU and fixed on the BLU by double-sided tape. The BLU provides light emitting elements distributed uniformly and sufficient brightness for the display

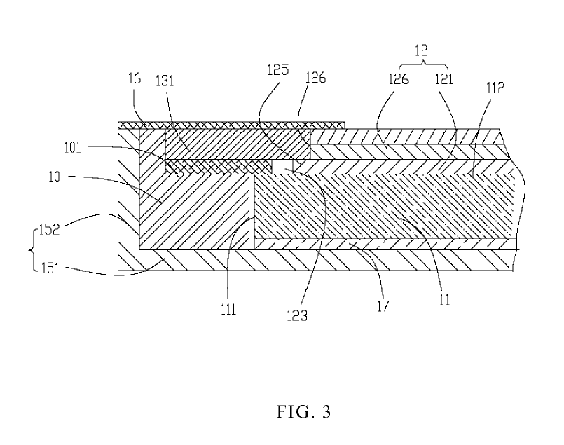

Referring FIGS. 2 and 3, the BLU includes a plastic frame 10, a light guide plate 11, an optical film group 12, and at least one light source 13. The light source 13 and the light guide plate 11 are set and fixed in the plastic frame 10. The light guide plate 11 includes a light incident surface 111 and a light emitting surface 112 next to the light incident surface 111. The light source 13 is set relative to the light incident surface 111 of the light guide plate 11. The optical film group 12 includes a first film 121 having a first lateral side 122. The first lateral side 122 has at least two notches 123. The first film 121 is set on the light emitting surface 112, and the first lateral side 122 and the light incident surface 111 are on the same plane. The light source 13 is located between the two notches 123.

In this embodiment, the first film 121 includes a plate body 124 and an extensive plate 125 located on one side of the plate body 124. The extensive plate 125 is parallel to one side of the plate body 124 and extended from and away the plate body 124. The first lateral side 122 is one side of the extensive plate 125. Furthermore, a shape of the notch 123 is one of arc, semicircle, oval, triangle, and polygon. In this embodiment, the quantity of the notches 123 is N, and N is a natural number bigger than 1. There are predetermined pitches among N notches 123. The quantity of light source 13 is N−1, and the light source 13 is located between the adjacent two notches 123.

Specifically, the plate body 124 and the extensive plate 125 are integrated and form a rectangular plate. The extensive plate 125 includes a top surface 1251 and a bottom surface (not shown here). The first lateral side 122 connects the top surface 1251 and the bottom surface. The shape of the notch 123 is trapezoid. The N notches 123 are set on the first lateral side 122 next to each other and penetrate the top surface 1251 and a bottom surface.

In this embodiment, the N−1 light sources 13 are set on one side of light incident surface 111 of the light guide plate 11 next to each other in the plastic frame 10. The first film 121 of the optical film group 12 and the light incident surface 111 are set flush. Each light source 13 is located between the two adjacent notches 123 and the first film 121 between the two adjacent notches 123 shelters the light source 13. Therefore, forward brightness of the location of the light source 13 can be lowered and the problem that the bright region of the BLU is closer to the light source 13 can be solved

The optical film group 12 further includes a plurality of second films 126 which are stacked. The same side of each of the plurality of second films 126 is a second side 127. The second side 127 and the first side 122 face the same direction and they form stair configuration. In this embodiment, the plurality of second films 126 is set on the plate body 124 of the first side 122. The extensive plate 125 extends outside the second side 127 and exposes the top surface 1251. From the view of the first side 122, the second side 127 and the first side 122 form stair configuration and the second side 127 is lower than the first side 122.

Moreover, a region of the extensive plate 125 between the second side 127 and the first side 122 is a first stair 128. Namely, the top surface of the extensive plate 125 between two notches 123 is the first stair 128. There is a second stair 101 set inside of the plastic frame 10 and relative to the first stair 128. The light source 13 includes a circuit board 131 and a light-emitting element 132 set on the circuit board 131. The circuit board 131 is fixed on the first stair 128 and the second stair 101. In this embodiment, the light-emitting element 132 is light-emitting diode. The circuit board 131 is fixed on the first stair 128 and the second stair 101 by the double-sided tape. In this embodiment, the light source 13 can be N light-emitting diodes. In another embodiment, the light source 13 can include a light bar and N light-emitting elements on the light bar.

The BLU further includes a back plate 15 including a bottom plate 151 and a side plate 152. The plastic frame 10 and the optical film group 13 are fixed on the side plate 152 of the back plate 15 by the double-sided tape 16. There is a reflective sheet 17 set between the back plate 15 and the BLU.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. A backlight unit comprising: a plastic frame, a light guide plate, an optical film group, and at least one light source;
the light source and the light guide plate set and fixed in the plastic frame; the light guide plate comprising a light incident surface and a light emitting surface next to the light incident surface; the light source set relative to the light incident surface of the light guide plate; the optical film group comprising a first film having a first lateral side; the first lateral side having at least two notches; the first film set on the light emitting surface; the first lateral side and the light incident surface being on the same plane; and the light source located between the two notches.

2. The backlight unit of claim 1, wherein the first film comprises a plate body and an extensive plate, the extensive plate is parallel to one side of the plate body and extended from and away the plate body, and the first lateral side is one side of the extensive plate.

3. The backlight unit of claim 2, wherein optical film group comprises a plurality of second films which are stacked, the same side of each of the plurality of second films is a second side, and the second side and the first side face the same direction and they form stair configuration.

4. The backlight unit of claim 3, wherein a shape of the notch is selected from a group consisting of arc, semicircle, oval, triangle, and polygon.

5. The backlight unit of claim 3, wherein quantity of the notches is N, there are predetermined pitches among N notches, quantity of light source is N−1, and the light source is located between the adjacent two notches.

6. The backlight unit of claim 5, wherein a region of the extensive plate between the second side and the first side is a first stair, a second stair is set inside of the plastic frame and relative to the first stair, the light source comprises a circuit board and a light-emitting element set on the circuit board, and the circuit board is fixed on the first stair and the second stair.

7. The backlight unit of claim 6, wherein the first stair is between two notches.

8. The backlight unit of claim 7, further comprising a back plate comprising a bottom plate and a side plate, and the plastic frame and the optical film group are fixed on the side plate of the back plate by the double-sided tape.

9. The backlight unit of claim 8, wherein a reflective sheet is set between the back plate and the BLU.

10. A display, comprising a backlight unit (BLU) and a liquid crystal (LC) panel, the LC panel set on the BLU and fixed on the BLU by double-sided tape, wherein the BLU comprises a plastic frame, a light guide plate, an optical film group, and at least one light source; the light source and the light guide plate set and fixed in the plastic frame; the light guide plate comprising a light incident surface and a light emitting surface next to the light incident surface; the light source set relative to the light incident surface of the light guide plate; the optical film group comprising a first film having a first lateral side; the first lateral side having at least two notches; the first film set on the light emitting surface; the first lateral side and the light incident surface being on the same plane; and the light source located between the two notches.

11. The display of claim 10, wherein the first film comprises a plate body and an extensive plate, the extensive plate is parallel to one side of the plate body and extended from and away the plate body, and the first lateral side is one side of the extensive plate.

12. The display of claim 11, wherein optical film group comprises a plurality of second films which are stacked, the same side of each of the plurality of second films is a second side, and the second side and the first side face the same direction and they form stair configuration.

13. The display of claim 12, wherein a shape of the notch is selected from a group consisting of arc, semicircle, oval, triangle, and polygon.

14. The display of claim 12, wherein quantity of the notches is N, there are predetermined pitches among N notches, quantity of light source is N−1, and the light source is located between the adjacent two notches.

15. The display of claim 14, wherein a region of the extensive plate between the second side and the first side is a first stair, a second stair is set inside of the plastic frame and relative to the first stair, the light source comprises a circuit board and a light-emitting element set on the circuit board, and the circuit board is fixed on the first stair and the second stair.

16. The display of claim 15, wherein the first stair is between two notches.

17. The display of claim 16, further comprising a back plate comprising a bottom plate and a side plate, and the plastic frame and the optical film group are fixed on the side plate of the back plate by the double-sided tape.

18. The display of claim 17, wherein a reflective sheet is set between the back plate and the BLU
